(19) United States
(12) Patent Application Publication
(10) Pub. No.: US 2017/0105366 A1
(43) Pub. Date: Apr. 20, 2017

(54) Tree resin collector

(71) Applicant: Daniel Mc Tear, St-Jerome (CA)

(72) Inventor: Daniel Mc Tear, St-Jerome (CA)

(21) Appl. No.: 15/290,151

(22) Filed: Oct. 11, 2016

(30) Foreign Application Priority Data
Oct. 15, 2015 (CA) 2908582

(51) Int. Cl. A01G 23/14

(52) U.S. Cl. CPC A01G 23/14

(57) ABSTRACT

A tree resin collector usable in combination with a bottle, the tree resin collector including: a collecting portion defining opposed collecting portion distal and proximal ends, the collecting portion defining a collecting edge at the collecting portion distal end; a guiding portion extending from the collecting portion proximal end, the guiding portion defining opposed guiding portion proximal and distal ends, the guiding portion extending from the collecting portion at the guiding portion distal end, the guiding portion being terminated opposed to the collecting portion by a mouth engaging section insertable in a mouth of the bottle; and a finish engaging portion provided substantially adjacent the mouth engaging section for engaging a finish of the bottle and securing the tree resin collector thereto with the mouth engaging section inserted in the mouth.

### FIELD OF THE INVENTION

The present invention relates to the general field of plant products harvesting, and is particularly concerned with a tree resin collector.

### BACKGROUND

Tree resin, for example fir resin, is conventionally collected manually, usually using artisanal tools. For example, the tree resin may be collected using a conventional cylindrical food can that has been altered to present a sharpened upper edge. This sharpened edge is used to piece through a resin blister on the trunk of the tree. The resin is then collected in the can by simply letting it flow thereinto while the can is pressed firmly against the tree. This method often results in resin flowing outside of the can, which soils the can and often the hand or gloves of the harvester. Since the resin is sticky, this also results in pieces of tree bark and other contaminants to stick to the can, hand or glove. Also, once the can is full, its content must be transferred to a container, which may be relatively difficult and time consuming given the sticky and viscous nature of the resin. This operation also presents many opportunities for the various debris stuck to the can and harvester to fall into the container.

Accordingly, there exists a need for an improved device for improved tree resin collectors. It is a general objective of the present invention to provide such a tree resin collector.

### SUMMARY OF THE INVENTION

In a broad aspect, the invention provides a tree resin collector usable in combination with a bottle, the bottle defining a mouth leading thereinto and a finish surrounding the mouth, the tree resin collector including: a collecting portion defining substantially opposed collecting portion distal and proximal ends, the collecting portion defining a collecting edge at the collecting portion distal end, the collecting portion being configured and sized for guiding tree resin from the collecting edge to the collecting portion proximal end; a guiding portion extending from the collecting portion proximal end, the guiding portion defining substantially opposed guiding portion proximal and distal ends, the guiding portion extending from the collecting portion at the guiding portion distal end, the guiding portion being terminated opposed to the collecting portion by a mouth engaging section insertable in the mouth, the guiding portion being configured and sized for guiding the tree resin from the collecting portion to the bottle; and a finish engaging portion provided substantially adjacent the mouth engaging section for engaging the finish and securing the tree resin collector thereto with the mouth engaging section inserted in the mouth.

The invention may also provide a tree resin collector wherein the mouth engaging section defines a mouth engaging section longitudinal axis, the guiding portion defining a main section, the main section being substantially elongated and extending from the mouth engaging section obliquely relative to the mouth engaging section longitudinal axis.

The invention may also provide a tree resin collector wherein the collecting portion tapers in a direction leading from the collecting portion distal end towards the collecting portion proximal end along at least part thereof.

The invention may also provide a tree resin collector wherein the collecting portion is substantially trapezoid-shaped.

The invention may also provide a tree resin collector where the collecting portion is substantially isosceles trapezoid-shaped.

The invention may also provide a tree resin collector wherein the guiding portion is hollow and defines a guiding portion passageway extending therethrough between the guiding portion proximal and distal ends.

The invention may also provide a tree resin collector wherein the collecting portion is concave and defines a collecting portion outlet at the collecting portion proximal end, the guiding portion passageway being in a fluid communication relationship with the collecting portion outlet.

The invention may also provide a tree resin collector wherein the collecting edge is substantially arcuate.

The invention may also provide a tree resin collector wherein the collecting edge is substantially rectilinear.

The invention may also provide a tree resin collector wherein the collecting edge is crenelated.

The invention may also provide a tree resin collector wherein the collecting edge is serrated.

The invention may also provide a tree resin collector further including auxiliary edges extending from the collecting edge at an angle relative thereto.

The invention may also provide a tree resin collector wherein the finish engaging portion includes a peripheral wall provided radially outwardly relative to the mouth engaging section, the tree resin collector further defining a substantially annular finish engaging recess between the peripheral wall and the mouth engaging section for receiving the finish thereinto when the tree resin collector is operatively mounted to the bottle.

The invention may also provide a tree resin collector further including a substantially annular finish sealing wall between the peripheral wall and the mouth engaging section, the finish sealing wall distally closing the finish receiving recess.

The invention may also provide a tree resin collector wherein the finish is threaded and the peripheral wall is threaded and screwable to the finish.

The invention may also provide a tree resin collector wherein the mouth engaging section is substantially cylindrical.

The invention may also provide a tree resin collector wherein the collecting, guiding and finish engaging portions are all reversibly attachable to each other.

In another broad aspect, the invention provides in combination, the tree resin collector as hereinabove and a bottle, the tree resin collector being attached to the bottle through the finish engaging portion.

The invention may also provide a combination wherein the bottle is removably attached to the tree resin collector.

The invention may also provide a combination wherein the bottle is a plastic bottle.

In another broad aspect, the invention provides a tree resin collector usable in combination with a bottle, the bottle defining a mouth leading thereinto and a finish surrounding the mouth, the tree resin collector including: a collecting portion defining substantially opposed collecting portion distal and proximal ends, the collecting portion defining a collecting edge at the collecting portion distal end, the collecting portion being configured and sized for guiding tree resin from the collecting edge to the collecting portion proximal end; a guiding portion extending from the collecting portion proximal end, the guiding portion defining substantially opposed guiding portion proximal and distal ends, the guiding portion extending from the collecting portion at the guiding portion distal end, the guiding portion being configured and sized for guiding the tree resin from the collecting portion to the bottle; and a finish engaging portion provided substantially adjacent the guiding portion proximal end for engaging the finish and securing the tree resin collector thereto.

The present application claims priority from Canadian Patent Application 2,908,582 filed on Oct. 15, 2015, the contents of which is hereby incorporated by reference in its entirety.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the drawings:

FIG. 1, in a side elevation view, illustrates a tree resin collector in accordance with an embodiment of the present invention;

FIG. 2, in a partial side cross-sectional view, illustrates the tree resin collector shown in FIG. 1 adjacent the;

FIG. 3, in an exploded perspective view, illustrates a tree resin collector in accordance with an alternative embodiments of the invention;

FIG. 4, in a perspective view, illustrates the tree resin collector shown in FIG. 1;

FIG. 5, in a perspective view, illustrates a tree resin collector in accordance with an other alternative embodiment of the present invention;

FIG. 6, in a perspective view, illustrates a tree resin collector in accordance with yet an other alternative embodiment of the present invention;

FIG. 7, in a perspective view, illustrates an alternative collecting edge usable in the tree resin collector shown in FIGS. 1 to 6; and

FIG. 8, in a perspective view, illustrates an other alternative collecting edge usable in the tree resin collector shown in FIGS. 1 to 6;

FIG. 9, in a perspective view, illustrates a collecting portion including yet an other alternative collecting edge usable in the tree resin collector shown in FIGS. 1 to 6; and

FIG. 10, in a perspective view, illustrates a collecting portion including yet an other alternative collecting edge usable in the tree resin collector shown in FIGS. 1 to 6.

### DETAILED DESCRIPTION

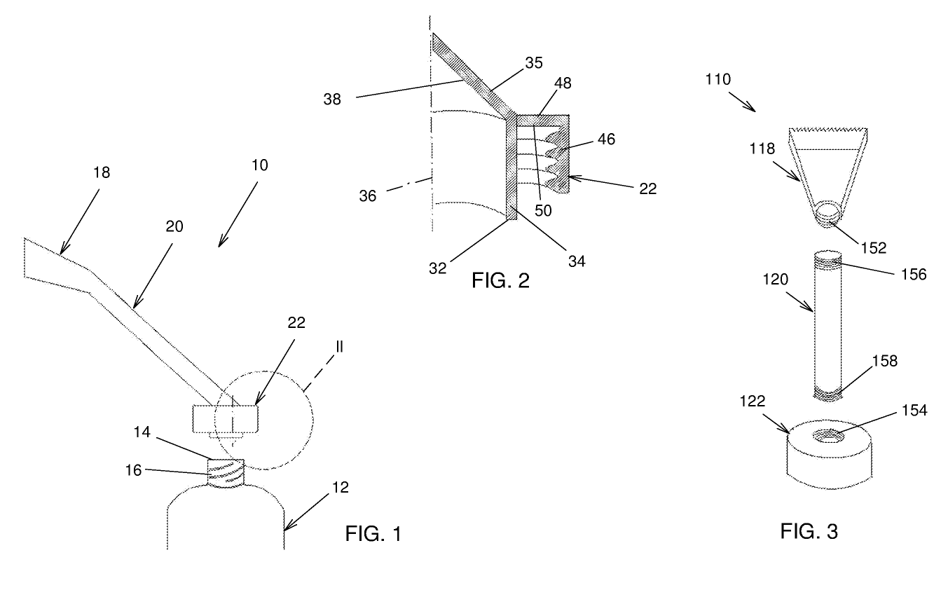

Referring to FIG. 1, there is shown a tree resin collector 10 usable in combination with a bottle 12, which is typically removably attachable thereto. The bottle 12 is made of plastic or any other suitable material and defines a mouth 14 leading thereinto and a finish 16 surrounding the mouth 14. The tree resin collector 10 includes a collecting portion 18, a guiding portion 20 and a finish engaging portion 22.

Referring to FIG. 4, for example, the collecting portion 18 defines substantially opposed collecting portion distal and proximal ends 24 and 26. The collecting portion 18 defines a collecting edge 28 at the collecting portion distal end 24. The collecting edge 28 is the portion of the tree resin collector 10 that will abut against the trunk of a tree to receive the tree resin (not shown in the drawings) when the tree resin collector 10 is in use. In some embodiments, the collecting edge 28 is also usable to breach a resin blister (not shown in the drawings) to access the tree resin. The collecting portion 18 is configured and sized for guiding the tree resin from the collecting edge 28 to the collecting portion proximal end 26.

The term “substantially” is used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention. These variations are to be interpreted from the point of view of the person skilled in the art. Also, the terminology distal refer to portions of the tree resin collector 10 that are further away from the bottle 12, while proximal refers to portions of the tree resin collector 10 that are closer to the bottle 12.

The guiding portion 20, extends from the collecting portion proximal end 26. The guiding portion 20 defines substantially opposed guiding portion distal and proximal ends 30 and 32, the latter being obscured in FIG. 4 and better seen in FIG. 2. The guiding portion 20 extends from the collecting portion 18 at the guiding portion distal end 30 and is terminated opposed to the collecting portion 18 by a mouth engaging section 34 insertable in the mouth 14. The mouth engaging section 34 is for example substantially cylindrical. The guiding portion 20 is configured and sized for guiding the tree resin from the collecting portion 18 to the bottle 12. The guiding portion 20 may be relatively short or relatively long compared to the collecting portion 18. The guiding portion 20 may extend integrally as a single piece of material from the collecting portion 18, may be permanently secured thereto, or can be detachable therefrom.

The finish engaging portion 22 is provided substantially adjacent the mouth engaging section 34 for engaging the finish 16 and securing the tree resin collector 10 thereto with the mouth engaging section 34 inserted in the mouth 14.

The mouth engaging section 34 defines a mouth engaging section longitudinal axis 36. In some embodiments, the guiding portion 20 is substantially elongated, and in some embodiments defines a main section 35, the main section 35 being substantially elongated and extending from the mouth engaging section 34 obliquely relative to the mouth engaging section longitudinal axis 36. The main section 35 extends between the mouth engaging section 34 and the collecting portion 18. The main section 35 may be for example substantially rectilinear, but other configurations are within the scope of the invention. This configuration spaces horizontally the mouth engaging section 34 from the collecting edge 28 when the mouth engaging section longitudinal axis 36 is vertical, which allows harvesting the tree resin while keeping the bottle 12 vertical or nearly vertical while spacing apart the bottle 12 from the a tree trunk. However, is it within the scope of the invention to have guiding portions 20 that are entirely coaxial with the mouth engaging section longitudinal axis 36.

The guiding portion 20 is typically hollow and defines a guiding portion passageway 38 extending therethrough between the guiding portion proximal and distal ends 32 and 30. For example, the guiding portion 20 has a generally cylindrical configuration along most of its length terminated by an elbow 40 from which the mouth engaging section 34 extends, as seen in FIG. 2 for example.

Returning to FIG. 4, the collecting portion 18 typically tapers in a direction leading from the collecting portion distal end 24 towards the collecting portion proximal end 26 along at least part thereof. For example, the collecting portion 18 is substantially trapezoid-shaped. In a very specific embodiment of the invention, the collecting portion 18 is substantially isosceles trapezoid-shaped.

The collecting portion 18 is for example generally concave and defines a collecting portion outlet 42 at the collecting portion proximal end 26, the guiding portion passageway 38 being in a fluid communication relationship with the collecting portion outlet 42. In a very specific example of implementation, the collecting portion 18 includes a substantially flat and trapezoid-shaped collecting wall 41 from which extend generally perpendicularly therefrom a pair of laterally opposed side walls 43 and 45, each extending between the collecting portion proximal and distal ends 26 and 24. At the collecting portion distal end 24, an end wall 47 extends from the collecting wall 41 between the side walls 43 and 45. The collecting edge 28 is defined by the end wall 47, opposed to the collecting wall 41. In some embodiments, the end wall 47 extends generally parallel to the mouth engaging section longitudinal axis 36. The collecting portion outlet 42 is defined between the side walls 43 and 45 at the collecting portion proximal end 26.

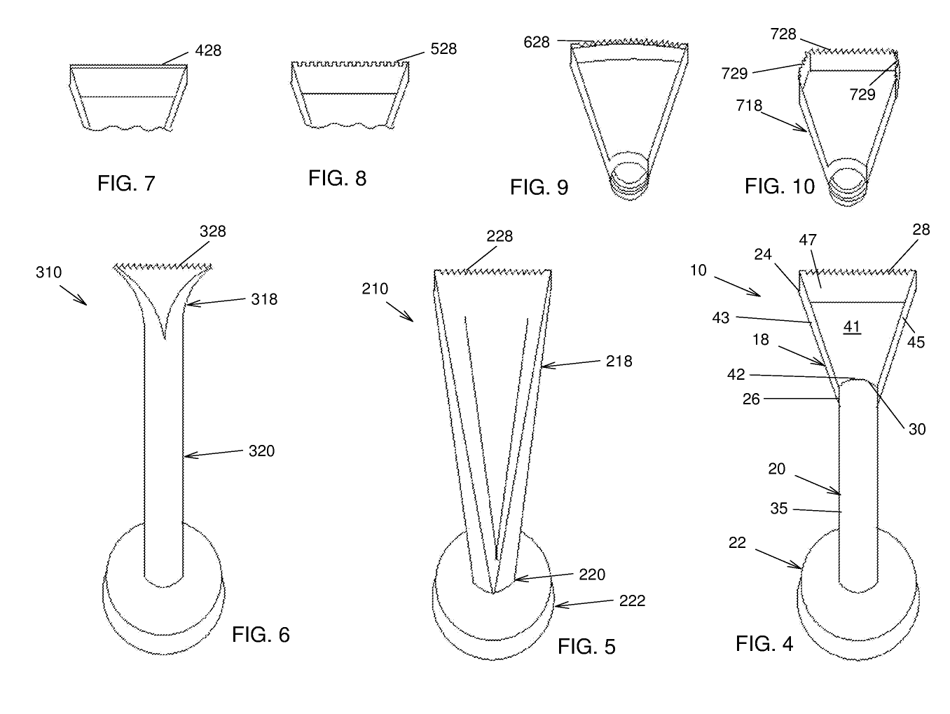

In other embodiments, as seen in FIGS. 5 and 6 for tree resin collectors 210 and 310 respectively, the collecting portion 218 and 318 respectively is defined by a concave wall extending between the collecting edge 228 and 328 and the guiding portion 220 and 320. With reference to FIG. 6, the collecting portion 318 may be relatively short, with a relatively long guiding portion 320. The collecting portion is shaped like a frustum of an hyperbolic cone from which a generally triangular slit has been removed. Alternatively, as seen in FIG. 5, the collecting portion 218 may be relatively long with a relatively short guiding portion 220, which is mostly obscured by the finish engaging portion 222 in FIG. 5. The collecting portion 218 may be for example formed of folded sheet metal, while the collecting portions 18 and 318 may be formed of a molded polymeric material.

Other materials are also within the scope of the invention.

The collecting edge 28 may have any suitable suitable form. For example, the collecting edge 28 is serrated. FIG. 7 illustrates an alternative collecting edge 428 that is substantially rectilinear. The collecting edge 428 may also be formed in a beveled portion of the collecting portion 18a to form a sharpened collecting edge 428. FIG. 8 illustrates an other alternative collecting edge 528 that is crenelated. The collecting edges 28, 428 and 528 all extend linearly. In alternative embodiments, as in the collecting edge 628 shown in FIG. 9, the collecting edge 628 is arcuate. The collecting edge 628 is serrated, but other types of collecting edges 628 are within the scope of the invention, such as beveled or crenelated collecting edges. FIG. 10 illustrate yet another collecting portion 718 including auxiliary edges 729 extending from the collecting edge 728 at an angle relative thereto. Thus, the auxiliary and collecting edges 729 and 728 form a generally U-shaped edge that may facilitate collecting of tree resin on tree trunks from which extend tightly packed branches. Other suitable shapes of collecting edges 28 are also within the scope of the invention.

As seen in FIG. 2, the finish engaging portion 22 includes a peripheral wall 46 provided radially outwardly relative to the mouth engaging section 34. The peripheral wall 46 is coupled to the remainder of the tree resin collector 10 in any suitable manner. For example, a substantially annular finish sealing wall 48 extends between the peripheral wall 46 and the mouth engaging section 34, at the distal end of the peripheral wall 46.

The tree resin collector 10 defines a substantially annular finish engaging recess 50 between the peripheral wall 46 and the mouth engaging section 34 for receiving the finish 16 (not shown in FIG. 2) thereinto when the tree resin collector 10 is operatively mounted to the bottle 12. The finish sealing wall 48 distally closes the finish engaging recess 50 so that access to the mouth 14 is only possible through the tree resin collector 10 when the latter is operatively mounted to the bottle 12.

In some embodiments, the finish 16 is threaded and the peripheral wall 46 is also threaded and screwable to the finish 16. However, in alternative embodiments, the peripheral wall 46 engages the finish 16 in any other suitable manner. For example, the peripheral wall 46 may be configured for frictionally engaging the finish 16. Also, in other embodiments, the peripheral wall 46 may include a resiliently deformable material, such as rubber, and slightly stretch when the finish 16 is inserted in the finish engaging recess 50 to secure the tree resin collector 10 to the bottle 12.

As seen in FIG. 3, in some embodiments, the tree resin collector 110 is such that the collecting portion 18, guiding portion 20 and finish engaging portion 22 are all reversibly attachable to each other, using threaded male and female portions. For example the collecting portion 118 and mouth engaging portion 122 both present threaded apertures 152 and 154 respectively to which threaded end portions 156 and 158 of the guiding portion 120 can be screwed. This embodiment may facilitate cleaning the tree resin collector 10. In other embodiments, the collecting portion 18, guiding portion 20 and finish engaging portion 22 are integrally formed with each other, as in the tree resin collector seen in FIGS. 1, 2 and 4.

Other variants are within the scope of the invention. For example, in some embodiments (not shown in the drawings), the mouth engaging section 34 is omitted and the tree resin collector 10 is terminated by the peripheral wall 46. Also, the when the mouth engaging section 34 is provided, the mouth engaging section 34 may protrude from the peripheral wall 46, be flush therewith or be retracted therefrom.

In an example of use, the bottle 12 is screwed to the peripheral wall 46. Afterwards, a tree resin harvester abuts the collecting edge 28 against a tree trunk below a resin blister and moves the collecting edge 28 upwardly to breach the resin blister. This allows flow of the resin contained in the resin blister into successively the collecting portion 18, guiding portion 20, and bottle 12. Once the resin blister has been emptied, tree resin is collected from other resin blisters until the bottle 12 is filled partially or completely. The bottle 12 can then be unscrewed from the peripheral wall 46 and capped with a conventional cap.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

1. A tree resin collector usable in combination with a bottle, the bottle defining a mouth leading thereinto and a finish surrounding the mouth, the tree resin collector comprising:
a collecting portion defining substantially opposed collecting portion distal and proximal ends, the collecting portion defining a collecting edge at the collecting portion distal end, the collecting portion being configured and sized for guiding tree resin from the collecting edge to the collecting portion proximal end;
a guiding portion extending from the collecting portion proximal end, the guiding portion defining substantially opposed guiding portion proximal and distal ends, the guiding portion extending from the collecting portion at the guiding portion distal end, the guiding portion being terminated opposed to the collecting portion by a mouth engaging section insertable in the mouth, the guiding portion being configured and sized for guiding the tree resin from the collecting portion to the bottle; and
a finish engaging portion provided substantially adjacent the mouth engaging section for engaging the finish and securing the tree resin collector thereto with the mouth engaging section inserted in the mouth.

2. The tree resin collector as defined in claim 1, wherein the mouth engaging section defines a mouth engaging section longitudinal axis, the guiding portion defining a main section, the main section being substantially elongated and extending from the mouth engaging section obliquely relative to the mouth engaging section longitudinal axis.

3. The tree resin collector as defined in claim 1, wherein the collecting portion tapers in a direction leading from the collecting portion distal end towards the collecting portion proximal end along at least part thereof.

4. The tree resin collector as defined in claim 3, wherein the collecting portion is substantially trapezoid-shaped.

5. The tree resin collector as defined in claim 4, where the collecting portion is substantially isosceles trapezoid-shaped.

6. The tree resin collector as defined in claim 1, wherein the guiding portion is hollow and defines a guiding portion passageway extending therethrough between the guiding portion proximal and distal ends.

7. The tree resin collector as defined in claim 6, wherein the collecting portion is concave and defines a collecting portion outlet at the collecting portion proximal end, the guiding portion passageway being in a fluid communication relationship with the collecting portion outlet.

8. The resin collector as defined in claim 1, wherein the collecting edge is substantially arcuate.

9. The resin collector as defined in claim 1, wherein the collecting edge is substantially rectilinear.

10. The resin collector as defined in claim 1, wherein the collecting edge is crenelated.

11. The resin collector as defined in claim 1, wherein the collecting edge is serrated.

12. The resin collector as defined in claim 1, further comprising auxiliary edges extending from the collecting edge at an angle relative thereto.

13. The tree resin collector as defined in claim 1, wherein the finish engaging portion includes a peripheral wall provided radially outwardly relative to the mouth engaging section, the tree resin collector further defining a substantially annular finish engaging recess between the peripheral wall and the mouth engaging section for receiving the finish thereinto when the tree resin collector is operatively mounted to the bottle.

14. The tree resin collector as defined in claim 13, further comprising a substantially annular finish sealing wall between the peripheral wall and the mouth engaging section, the finish sealing wall distally closing the finish receiving recess.

15. The tree resin collector as defined in claim 13, wherein the finish is threaded and the peripheral wall is threaded and screwable to the finish.

16. The tree resin collector as defined in claim 1, wherein the mouth engaging section is substantially cylindrical.

17. The tree resin collector as defined in claim 1, wherein the collecting, guiding and finish engaging portions are all reversibly attachable to each other.

18. In combination, the tree resin collector as defined in claim 1 and a bottle, the tree resin collector being attached to the bottle through the finish engaging portion.

19. The combination as defined in claim 18, wherein the bottle is removably attached to the tree resin collector.

20. The combination as defined in claim 19, wherein the bottle is a plastic bottle.

21. A tree resin collector usable in combination with a bottle, the bottle defining a mouth leading thereinto and a finish surrounding the mouth, the tree resin collector comprising:
a collecting portion defining substantially opposed collecting portion distal and proximal ends, the collecting portion defining a collecting edge at the collecting portion distal end, the collecting portion being configured and sized for guiding tree resin from the collecting edge to the collecting portion proximal end;
a guiding portion extending from the collecting portion proximal end, the guiding portion defining substantially opposed guiding portion proximal and distal ends, the guiding portion extending from the collecting portion at the guiding portion distal end, the guiding portion being configured and sized for guiding the tree resin from the collecting portion to the bottle; and
a finish engaging portion provided substantially adjacent the guiding portion proximal end for engaging the finish and securing the tree resin collector thereto.
